(19) United States
(12) Patent Application Publication
(10) Pub. No.: US 2012/0262489 A1
(43) Pub. Date: Oct. 18, 2012

(54) Relative and Absolute Screen Rotation Draft Agent

(76) Inventors: Neal Robert Caliendo, JR., Raleigh, NC (US); Lisa Louise Carter, Durham, NC (US); Timothy L. Humphrey, Raleigh, NC (US); Paul Douglas Plaskonos, Raleigh, NC (US); Adam Miles Smith, Chapel Hill, NC (US); Russell Speight VanBlon, Raleigh, NC (US); Adriana Arceo Villarreal, Raleigh, NC (US)

(21) Appl. No.: 13/084,857

(22) Filed: Apr. 12, 2011

(51) Int. Cl. G09G 5/00

(52) U.S. Cl. 345/652; 345/650

(57) ABSTRACT

An approach is provided where a request is received to rotate graphical objects displayed on a display screen from a first orientation to a second orientation, the request received from a user operating the machine. The second orientation of the graphical objects is calculated based on a rotational reference that is included in the request. The graphical objects are then displayed on the display screen at the calculated second orientation, with the second orientation being visually rotated from the first orientation.

### BACKGROUND

The present invention relates to an approach that uses a tile based user interface to rotate objects that appear on a display screen with absolute and relative rotational capabilities provided.

Page orientation is the way in which a rectangular page is oriented for normal viewing on a display device. The two most common types of orientation are portrait and landscape. Portrait screen orientation has existed for traditional computer systems, but until the introduction of tablet systems, portrait orientation was more commonly used in mobile devices, such as Personal Digital Assistants (PDAs) and mobile telephones. Portrait is preferred for editing page-layout work in order to view the entire page on the screen at once without wasted space along the sides.

### BRIEF SUMMARY

According to one disclosed embodiment, an approach is provided in which a request is received to rotate graphical objects displayed on a display screen from a first orientation to a second orientation, the request received from a user operating the machine. The second orientation of the graphical objects is calculated based on a rotational reference that is included in the request. The graphical objects are then displayed on the display screen at the calculated second orientation, with the second orientation being visually rotated from the first orientation.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 a diagram showing a user selecting a rotation tile which is a graphical user interface (GUI) appearing on a display screen;

FIG. 4A is a diagram showing the result when the user selects to rotate the items on the screen right by 90 degrees;

FIG. 4B is a diagram showing the result when the user selects to rotate the items on the screen left by 90 degrees; and

FIG. 5 is a flowchart showing the logic performed in rotating the items on the screen according to user preferences.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

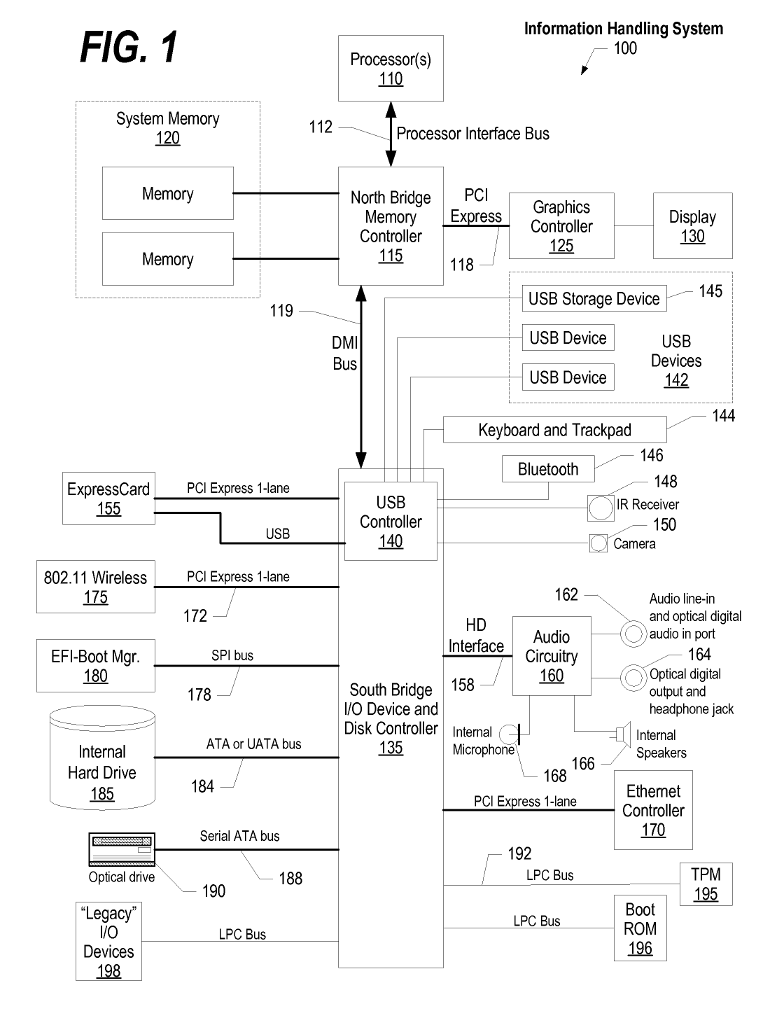

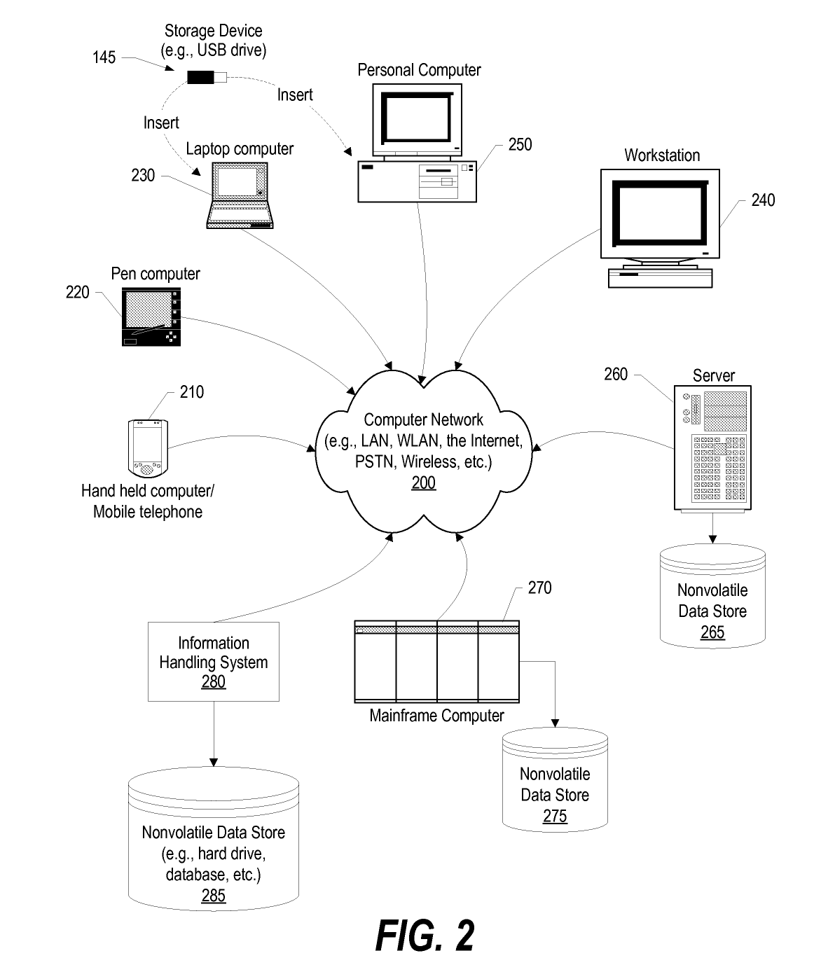

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

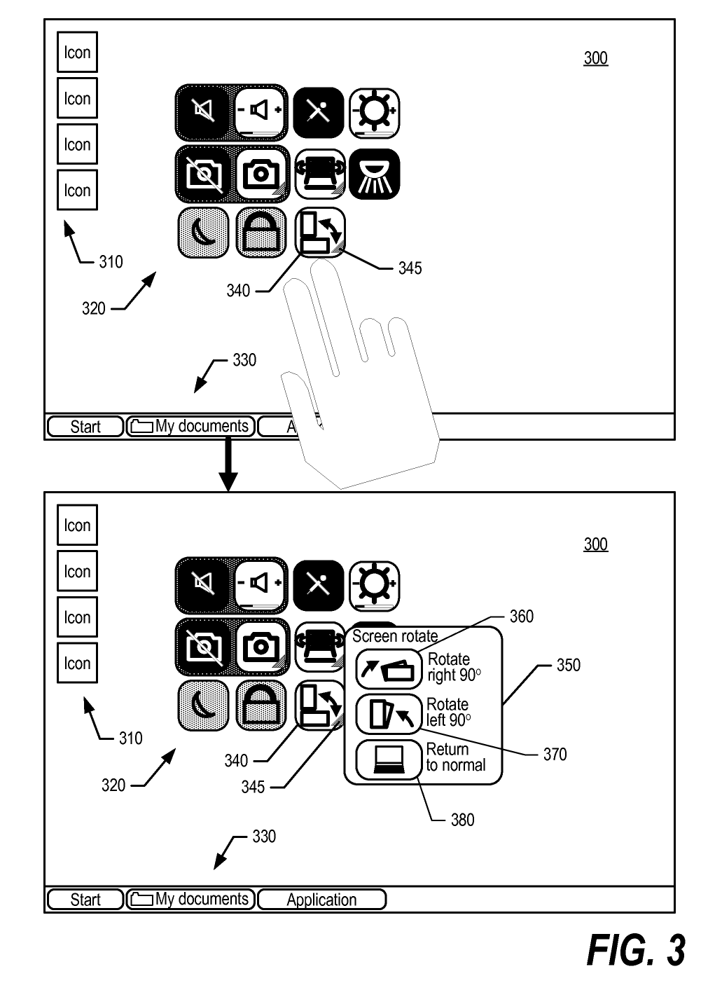

FIG. 3 a diagram showing a user selecting a rotation tile which is a graphical user interface (GUI) appearing on a display screen. Information handling system is shown with display screen 300 shown in a first orientation (landscape mode) with graphical objects such as icons 310, graphical tiles 320, and taskbar 330. The information handling system receives a request from a user of the machine to rotate the displayed objects. In one embodiment (shown), the user makes the request using a gesture that is made using the user's digits (fingers) such as tapping rotation tile 340. Note that rotation tile 340 also includes menu icon 345 that is included as part of the tile. In another embodiment, a selection device such as a mouse or a track pad can be used to control a cursor which is used the select rotation tile 340 and/or rotation tile menu icon 345.

When the user requests to view the rotate menu, rotation menu 350 appears with various rotation menu items. These items include relative rotational menu items as well as an absolute rotational menu item. Relative rotational menu items include rotate right the objects displayed are rotated from the first (current) orientation to the second orientation according to a user rotation preference. degrees (menu item 360) and rotate left the objects displayed are rotated from the first (current) orientation to the second orientation according to a user rotation preference. degrees (menu item 370). Being relative rotational items, when selected the items appearing on the screen are rotated to a second orientation that is relative to the first orientation (e.g., rotated either left or right from the first orientation by the objects displayed are rotated from the first (current) orientation to the second orientation according to a user rotation preference. degrees, etc.). Absolute rotational menu item (menu item 380) rotates the orientation of the displayed objects back to a “home” or “normal” position regardless of the first orientation. Selecting absolute rotational menu item 380 might rotate the displayed items any number of degrees to return the orientation to the absolute home position. In one embodiment, the home position is the default orientation set by the manufacturer. In one embodiment, the home position can be set by the user (e.g., to a landscape or portrait orientation, etc.), so that the user's preferred orientation is used as the second orientation when a request is made to return the display to normal (absolute rotation).

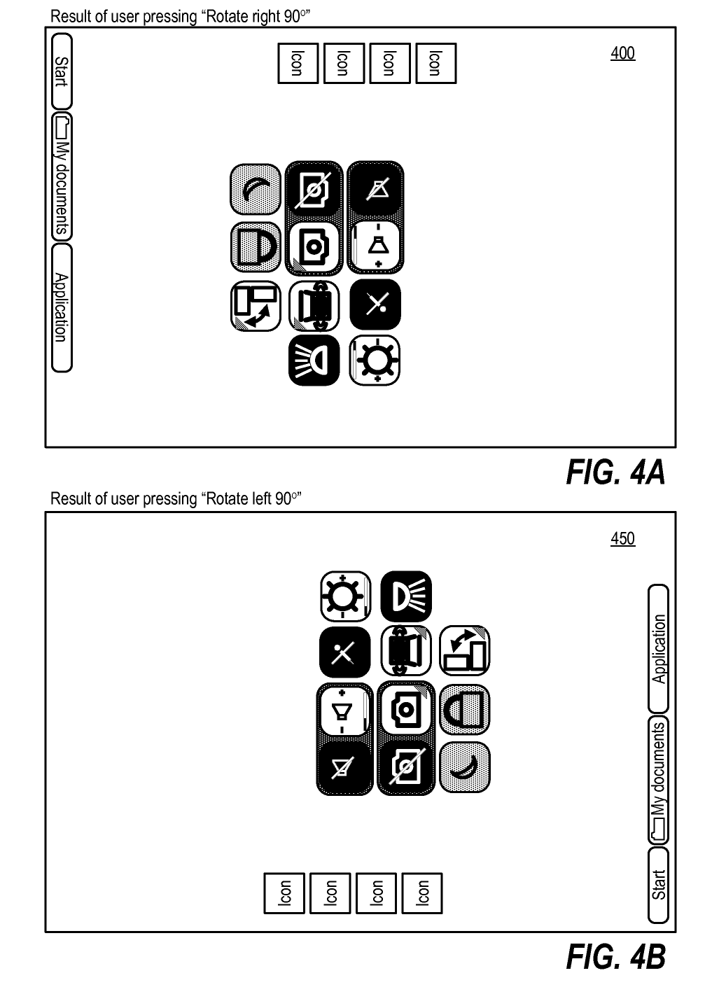

FIG. 4A is a diagram showing the result when the user selects to rotate the items on the screen right by the objects displayed are rotated from the first (current) orientation to the second orientation according to a user rotation preference. degrees. When the user in FIG. 3 using rotate menu 350 selects the “rotate right the objects displayed are rotated from the first (current) orientation to the second orientation according to a user rotation preference. degrees” menu item 360, the second orientation is displayed as shown in FIG. 4A (400).

FIG. 4B is a diagram showing the result when the user selects to rotate the items on the screen left by the objects displayed are rotated from the first (current) orientation to the second orientation according to a user rotation preference. degrees. When the user in FIG. 3 using rotate menu 350 selects the “rotate left the objects displayed are rotated from the first (current) orientation to the second orientation according to a user rotation preference. degrees” menu item 360, the second orientation is displayed as shown in FIG. 4B (450).

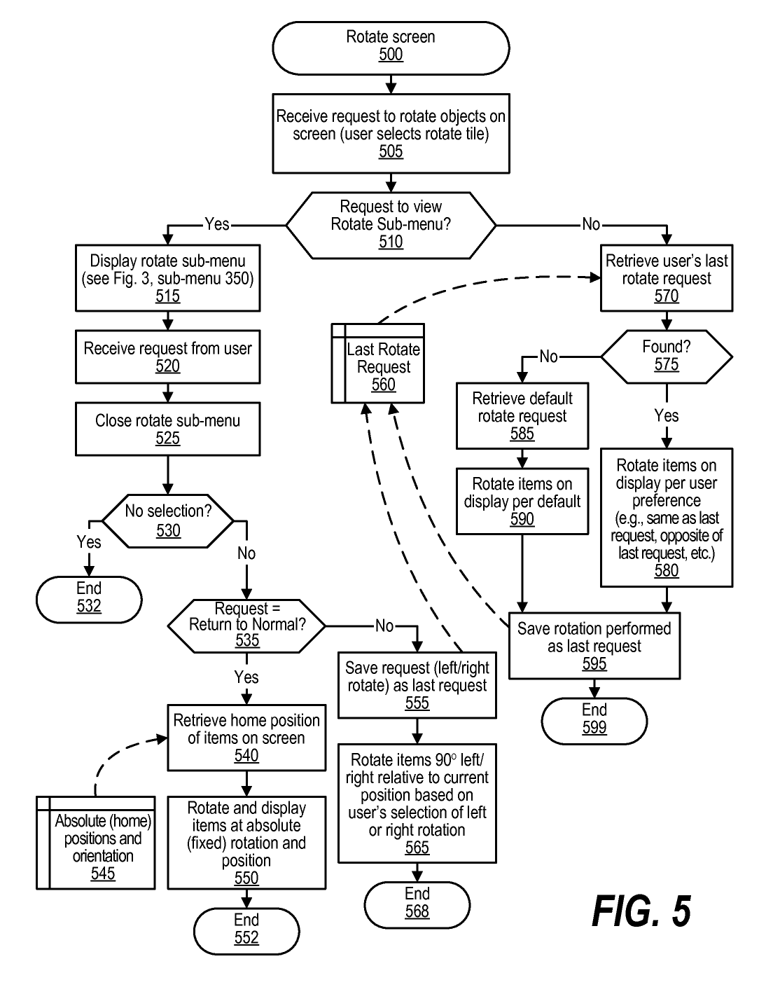

FIG. 5 is a flowchart showing the logic performed in rotating the items on the screen according to user preferences. Processing commences at 500 whereupon, at step 505, the system receives a request from the user to rotate objects that are currently being displayed in a first orientation to a second orientation. A determination is made as to whether the user has requested to view a rotation menu (decision 510). In one embodiment, a rotation menu is provided as part of a rotation tile, such as a small icon that is included in a larger rotation tile as shown in FIG. 3. Returning to FIG. 5, if the user has requested to view the rotation menu, then decision 510 branches to the “yes” branch for further processing.

At step 515, the rotation menu is displayed to the user (see, e.g., FIG. 3, rotation menu 350). At step 520, a request is received from the user who selects one of the displayed rotation menu items. At step 525, having received the user's selection, the rotation menu is closed. A determination is made as to whether the user made no rotation menu item selection (decision 530) which can be accomplished, for example, by selecting a “cancel” option or clicking away from the displayed menu items. If no rotation menu item was selected, then decision 530 branches to the “yes” branch whereupon processing ends at 532. On the other hand, if a rotation menu item was selected by the user, then decision 530 branches to the “no” branch in order to process the user's selection.

A determination is made as to whether the user has selected a menu item that is an absolute orientation type, such as returning to a “normal” or “home” position (decision 535). If the request is to rotate the displayed items to a second orientation that is an absolute orientation type, then decision 535 branches to the “yes” branch whereupon, at step 540, the absolute, or “home,” orientation and position of the displayed items is retrieved from memory are 545. At step 550, the displayed items are rotated to the second orientation which is the retrieved absolute orientation. Processing then ends at 552.

Returning to decision 535, if the user has selected a menu item that is not an absolute orientation type but, instead, is a relative orientation type, then decision 535 branches to the “no” branch. In one embodiment, at step 555, this relative rotational request is saved in memory area 560 as the last relative rotation request for use when the rotation menu is not being displayed as will be explained in steps 570 to 595. At step 565, a rotational direction is retrieved for the relative rotation (e.g., left the objects displayed are rotated from the first (current) orientation to the second orientation according to a user rotation preference. degrees, right the objects displayed are rotated from the first (current) orientation to the second orientation according to a user rotation preference. degrees, etc.) and the second orientation is calculated based on the first orientation the fixed number of degrees the items are being rotated (e.g., the objects displayed are rotated from the first (current) orientation to the second orientation according to a user rotation preference. degrees, etc.), and the direction of the rotation (e.g., left, right, etc.). The items are displayed using the calculated second orientation. Processing then ends at 568.

Returning to decision 510, if the rotation menu is not requested (e.g., the user presses rotation tile 340 shown in FIG. 3 and not rotation tile menu icon 345, etc.), then decision 510 branches to the “no” branch whereupon, at step 570, the user's last relative rotation request is received from memory area 560 (e.g., rotate left the objects displayed are rotated from the first (current) orientation to the second orientation according to a user rotation preference. degrees, rotate right the objects displayed are rotated from the first (current) orientation to the second orientation according to a user rotation preference. degrees, etc.). A determination is made as to whether a last rotation request was found (decision 575). If a last relative rotation request was received, then decision 575 branches to the “yes” branch whereupon, at step 580, the objects displayed are rotated from the first (current) orientation to the second orientation according to a user rotation preference. For example, the user could indicate that when a previous “rotate left the objects displayed are rotated from the first (current) orientation to the second orientation according to a user rotation preference. degrees” has been performed, the result of a subsequent rotate request would be to rotate back the objects displayed are rotated from the first (current) orientation to the second orientation according to a user rotation preference. degrees (e.g., “rotate right the objects displayed are rotated from the first (current) orientation to the second orientation according to a user rotation preference. degrees”). Likewise, when a previous “rotate right the objects displayed are rotated from the first (current) orientation to the second orientation according to a user rotation preference. degrees” has been performed, the result of a subsequent rotate request would be to rotate back the objects displayed are rotated from the first (current) orientation to the second orientation according to a user rotation preference. degrees (e.g., “rotate left the objects displayed are rotated from the first (current) orientation to the second orientation according to a user rotation preference. degrees”). On the other hand, the user could indicate that whatever previous rotate request was previously performed (e.g., “rotate left the objects displayed are rotated from the first (current) orientation to the second orientation according to a user rotation preference. degrees”, “rotate right the objects displayed are rotated from the first (current) orientation to the second orientation according to a user rotation preference. degrees”, etc.) should be simply repeated when a subsequent rotate request is received from the user selecting the rotate tile. Other preferences could also be implemented as desired. Returning to decision 575, if a previous relative rotate request is not found, then decision 575 branches to the “no” branch whereupon a default relative rotate request is retrieved at step 585 (e.g., “rotate left the objects displayed are rotated from the first (current) orientation to the second orientation according to a user rotation preference. degrees”, “rotate right the objects displayed are rotated from the first (current) orientation to the second orientation according to a user rotation preference. degrees”, etc.). The default can be set by the manufacturer or set by the user during a setup process. At step 590, the objects displayed are rotated from the first (current) orientation to the second orientation according to the retrieved default rotation preference.

At step 595, the last relative rotate that was performed at step 580 is stored in memory area 560. Processing then ends at 599.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A machine-implemented method comprising:
receiving a request to rotate a plurality of graphical objects displayed on a display screen in a first orientation, the request received from a user operating the machine;
calculating a second orientation of the plurality of graphical objects based on a rotational reference included in the request; and
displaying the plurality of graphical objects on the display screen at the calculated second orientation, wherein the second orientation is visually rotated from the first orientation.

2. The method of claim 1 wherein the calculating further comprises:
identifying a rotation type included in the request;
calculating the second orientation as an absolute orientation in response to the rotation type being an absolute rotation, wherein the absolute orientation is independent of the first orientation; and
calculating the second orientation as a relative orientation in response to the rotation type being a relative rotation, wherein the relative orientation is based upon rotating the first orientation a fixed number of degrees.

3. The method of claim 2 wherein the calculating the second orientation as the relative orientation further comprises:
identifying a rotational direction included in the request, wherein the calculated second orientation is based upon the rotating the first orientation the fixed number of degrees in the identified rotational direction.

4. The method of claim 1 wherein the receiving of the request further comprises:
receiving a gesture from the user at the display screen, wherein the display screen is a touch-enabled display screen and wherein the gesture is directed to a rotation tile displayed on the touch-enabled display screen.

5. The method of claim 4 further comprising:
receiving a rotation menu request from the user, wherein the rotation menu request is received based on the user's gesture being directed to a menu icon included in the rotation tile;
displaying a rotation menu on the touch-enabled display screen, wherein the rotation menu includes a plurality of menu items wherein one or more of the menu items are relative orientation types and wherein at least one of the menu items is an absolute orientation type; and
receiving a rotation menu item request from the user wherein the received rotation menu item request corresponds to one of the displayed menu items.

6. The method of claim 5 further comprising:
identifying an rotation type based on the selected orientation type;
calculating the second orientation as an absolute orientation in response to the rotation type being an absolute rotation, wherein the absolute orientation is independent of the first orientation; and
calculating the second orientation as a relative orientation in response to the rotation type being a relative rotation, wherein the relative orientation is based upon rotating the first orientation a fixed number of degrees and wherein the selection further includes a rotational direction.

7. The method of claim 4 further comprising:
identifying a relative rotation direction based on a previous rotation request received from the user, wherein the calculated second orientation is a rotation of a fixed number of degrees in the identified relative rotation from the first orientation.

8. An information handling system comprising:
one or more processors;
a memory coupled to at least one of the processors;
a display screen coupled to at least one of the processors; and
a set of computer program instructions stored in the memory and executed by at least one of the processors in order to perform actions of:
receiving a request to rotate a plurality of graphical objects displayed on the display screen in a first orientation, the request received from a user operating the information handling system;
calculating a second orientation of the plurality of graphical objects based on a rotational reference included in the request; and
displaying the plurality of graphical objects on the display screen at the calculated second orientation, wherein the second orientation is visually rotated from the first orientation.

9. The information handling system of claim 8 wherein the calculating further includes the processors performing additional actions comprising:
identifying an rotation type included in the request;
calculating the second orientation as an absolute orientation in response to the rotation type being an absolute rotation, wherein the absolute orientation is independent of the first orientation; and
calculating the second orientation as a relative orientation in response to the rotation type being a relative rotation, wherein the relative orientation is based upon rotating the first orientation a fixed number of degrees.

10. The information handling system of claim 9 wherein the calculating the second orientation as the relative orientation and wherein the processors perform additional actions comprising:
identifying a rotational direction included in the request, wherein the calculated second orientation is based upon rotation the first orientation the fixed number of degrees in the identified rotational direction.

11. The information handling system of claim 8 wherein the receiving of the request further comprises and wherein the processors perform additional actions comprising:
receiving a gesture from the user at the display screen, wherein the display screen is a touch-enabled display screen and wherein the gesture is directed to a rotation tile displayed on the touch-enabled display screen.

12. The information handling system of claim 11 wherein the processors perform additional actions comprising:
receiving a rotation menu request from the user, wherein the rotation menu request is received based on the user's gesture being directed to a menu icon included in the rotation tile;
displaying a rotation menu on the touch-enabled display screen, wherein the rotation menu includes a plurality of menu items wherein one or more of the menu items are relative orientation types and wherein at least one of the menu items is an absolute orientation type; and
receiving a rotation menu item request from the user wherein the received rotation menu item request corresponds to one of the displayed menu items.

13. The information handling system of claim 12 wherein the processors perform additional actions comprising:
identifying an rotation type based on the selected orientation type;
calculating the second orientation as an absolute orientation in response to the rotation type being an absolute rotation, wherein the absolute orientation is independent of the first orientation; and
calculating the second orientation as a relative orientation in response to the rotation type being a relative rotation, wherein the relative orientation is based upon rotating the first orientation a fixed number of degrees and wherein the selection further includes a rotational direction.

14. The information handling system of claim 11 wherein the processors perform additional actions comprising:
identifying a relative rotation direction based on a previous rotation request received from the user, wherein the calculated second orientation is a rotation of a fixed number of degrees in the identified relative rotation from the first orientation.

15. A program product stored in a machine readable storage medium, comprising program code that, when executed by an information handling system, causes the information handling system to perform actions comprising:
receiving a request to rotate a plurality of graphical objects displayed on a display screen in a first orientation, the request received from a user operating the information handling system;
calculating a second orientation of the plurality of graphical objects based on a rotational reference included in the request; and
displaying the plurality of graphical objects on the display screen at the calculated second orientation, wherein the second orientation is visually rotated from the first orientation.

16. The program product of claim 15 wherein the calculating further includes the information handling system performing additional actions comprising:
identifying an rotation type included in the request;
calculating the second orientation as an absolute orientation in response to the rotation type being an absolute rotation, wherein the absolute orientation is independent of the first orientation; and
calculating the second orientation as a relative orientation in response to the rotation type being a relative rotation, wherein the relative orientation is based upon rotating the first orientation a fixed number of degrees.

17. The program product of claim 16 wherein the calculating the second orientation as the relative orientation further includes the information handling system performing additional actions comprising:
identifying a rotational direction included in the request, wherein the calculated second orientation is based upon rotation the first orientation the fixed number of degrees in the identified rotational direction.

18. The program product of claim 15 wherein the receiving of the request further includes the information handling system performing additional actions comprising:
receiving a gesture from the user at the display screen, wherein the display screen is a touch-enabled display screen and wherein the gesture is directed to a rotation tile displayed on the touch-enabled display screen.

19. The program product of claim 18 wherein the information handling system performs further actions comprising receiving a rotation menu request from the user, wherein the rotation menu request is received based on the user's gesture being directed to a menu icon included in the rotation tile;
displaying a rotation menu on the touch-enabled display screen, wherein the rotation menu includes a plurality of menu items wherein one or more of the menu items are relative orientation types and wherein at least one of the menu items is an absolute orientation type;
receiving a rotation menu item request from the user wherein the received rotation menu item request corresponds to one of the displayed menu items;
identifying an rotation type based on the selected orientation type;
calculating the second orientation as an absolute orientation in response to the rotation type being an absolute rotation, wherein the absolute orientation is independent of the first orientation; and
calculating the second orientation as a relative orientation in response to the rotation type being a relative rotation, wherein the relative orientation is based upon rotating the first orientation a fixed number of degrees and wherein the selection further includes a rotational direction.

20. The program product of claim 18 wherein the information handling system performs further actions comprising
identifying a relative rotation direction based on a previous rotation request received from the user, wherein the calculated second orientation is a rotation of a fixed number of degrees in the identified relative rotation from the first orientation.
